(19) United States
(12) Patent Application Publication
(10) Pub. No.: US 2019/0283493 A1
(43) Pub. Date: Sep. 19, 2019

(54) WHEEL

(71) Applicant: DSM IP Assets B.V., Heerlen (NL)

(72) Inventors: Marc Rudolf Stefan HUISMAN, Echt (NL); Giacomo PERFETTI, Echt (NL)

(21) Appl. No.: 16/318,798

(22) PCT Filed: Jun. 19, 2017
(86) PCT No.: PCT/EP2017/064901

§ 371 Date: Jan. 18, 2019

(30) Foreign Application Priority Data
Jul. 21, 2016 (EP) 16180531.2

(51) Int. Cl. B60B 3/12; B29C 70/86; B60B 21/02; B60B 5/02

(52) U.S. Cl. CPC B60B 3/12; B29C 70/86; B60B 21/02; B60B 2360/36; B60B 2360/10; B60B 2360/34; B60B 5/02

(57) ABSTRACT

The invention relates to a wheel, comprising a metal disk and a rim which rim comprises a metal part and a continuous fiber reinforced composite part present on an outer surface of the metal part of the rim, wherein the continuous fiber reinforced composite part comprises a semi-crystalline polyamide with a melting temperature of at least 180° C. The invention also relates to a process for preparing a wheel as well as a tape for use in production of the wheel.

This invention relates to wheels comprising a metal disk and a rim comprising a metal part. The invention also relates to a process for preparing these wheels.

Wheels for automotive industry, both for cars and trucks, have to fulfil a number of requirements such as durability tests—like cornering fatigue, rim rolling fatigue, bi-axial fatigue, 13° impact and wheel stiffness, corrosion resistance demands e.g. against fuel and weathering, as well as vehicle dynamics, integrity and regulatory. Wheels for automotive industry usually have a wheel load capacity of at least 200 kg, in order to distinguish them from wheels of for example bicycles.

In order to reduce carbon dioxide emissions, it is important that the wheels are as light as possible, without having to compromise on functionality, safety and durability of the wheel. Nowadays, wheels consist of metal, to ensure these properties. Metal, however, has the disadvantage that it is rather heavy.

It is thus an object of the present invention to provide wheels that may be lighter, with the least compromise to durability and functionality.

Surprisingly, this object has been achieved by a wheel, comprising a metal disk and a rim which rim comprises a metal part and a continuous fiber reinforced composite part present on an outer surface of the metal part of the rim, wherein the continuous fiber reinforced composite part comprises a semi-crystalline polyamide with a melting temperature of at least 180° C.

The wheel according to the invention is lighter than conventional metal wheels, while providing durability that is sufficient for nowadays requirements for cars and trucks. The wheel according to the invention allows for better fuel efficiency and thus lower carbon dioxide emissions. The wheel also may allow for improved driving behavior such as for example precise steering, improved turning-in characteristics, more responsive acceleration and braking. The wheel may allow for better road contact, enhancing general safety.

Surprisingly, the lifetime of the wheel according to the invention is comparable to a full metal wheel without the need to compromise on functionality requirements such as a maximum speed or a maximum distance. The wheel according to the invention may be used as full replacement of a known metal wheel, thereby fully benefitting of the weight reduction during the lifetime of the vehicle.

### Wheel

The wheel according to the invention comprises a metal disk and a rim which rim comprises a metal part and a continuous fiber reinforced composite part.

The metal disk is a part known to a person skilled in the art and may be made of for example steel or aluminum.

The metal disk and the rim which comprises a metal part may be made of one part, as may be typically the case for wheels in which the metal is aluminum. However, the metal disk and the rim which comprises a metal part may also be assembled from two parts, which is usually the case for a wheel in which the metal is steel.

The outer surface of the metal part of the rim is defined as the surface facing the tire, in contrast to the side where the disk is present.

The rim of the wheel comprises a metal part and a continuous fiber reinforced composite part, which composite comprises a semi-crystalline polyamide with a melting temperature of at least 180° C. An advantage of having a rim of both metal and a composite, as compared to a full plastic wheel, is that the metal part of the rim allows for heat dissipation to prevent the semi-crystalline polyamide in the composite from melting when breaking.

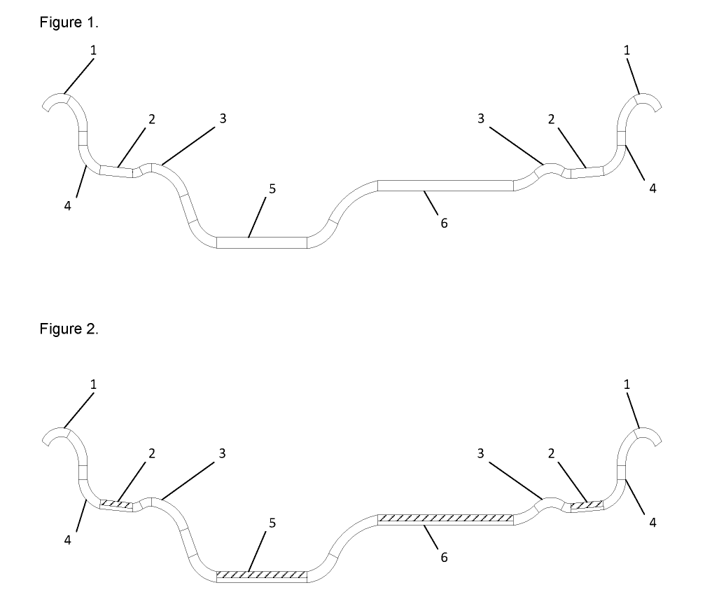

FIG. 1 shows a cross sectional part of a rim, also known as rim profile as known in the prior art.

| | |
|---|---|
| 1 | Flange |
| 2 | Bead seat |
| 3 | Bead hump |
| 4 | Radius |
| 5 | Drop center |
| 6 | Drop well |

FIG. 2 shows a cross sectional part of a rim of a wheel according to the invention, in which at the bead seats, drop center and drop well a composite is present.

The continuous fiber reinforced composite part is present on the outer surface of the metal part of the rim.

Preferably, the continuous fiber reinforced composite part is present at least one of either a bead seat (2), a drop well (6) or a drop center (5), or a combination thereof. More preferably the continuous fiber reinforced composite part is present at least a drop well (6), even more preferably at a drop well (6) and at least one bead seat (2), and most preferred at a drop well (6), both bead seats (2) and drop center (5). The continuous fiber reinforced composite may also be present on the drop center only. The continuous fiber reinforced composite may also be present at radii and bead humps.

The invention relates to a wheel which preferably has a wheel load capacity of at least 200 kg. Wheel load capacity is defined as the total weight of a vehicle to be carried by a number of wheels divided by the total number of wheels which will carry the vehicle. Wheels with higher wheel load capacity are required for heavier vehicles as these require higher safety and benefit more from weight reduction as compared to wheels with lower wheel load capacity.

The wheel has continuous fiber reinforced composite part present on an outer surface of the metal part of the rim, preferably wherein the continuous fiber is oriented in a radial direction.

### Continuous Fiber Reinforced Composite Comprising Semi-Crystalline Polyamide

Continuous fiber reinforced composite part comprising semi-crystalline polyamide is herein understood to be a composite in which continuous fiber is present in at least a semi-crystalline polyamide, and is also referred herein to as composite.

The continuous fiber reinforced composite part comprises semi-crystalline polyamide with a melting temperature of at least 180° C., such as for example PA-6, PA-66, PA-66/6, PA-6/66, PA-6/6T, PA-66/6T, PA-610, PA-410, PA-12, PA-46, PA-510, PA-612 as well as blends and copolyamides thereof.

With “semi-crystalline polyamide” is herein understood a polyamide having a melting enthalpy of at least 20 Joules/gram, using differential scanning calorimetry (DSC) pursuant to ASTM D3418-08 in the second heating run with a heating rate of 10° C./min.

Melting temperature of a polyamide can be determined by ISO 11357-1/-3 in the second heating run with a heating rate of 10 degC/min.

Preferably, the melting temperature is at least 190° C., more preferably at least 200° C., even more preferred at least 210° C. and most preferred at least 230° C. A higher melting temperature of the polyamide allows for higher residual mechanical properties and therefore safety at the governing temperature during braking. If more than one semi-crystalline polyamide is present, the melting temperature is defined as the highest melting temperature of the semi-crystalline present.

The continuous fiber reinforced composite part usually comprises the semi-crystalline polyamide in an amount of between 25 and 90 vol % with respect to the total volume of the continuous fiber reinforced composite, preferably the volume percentage is between 35 and 90 vol %, more preferably between 45 and 80 vol %, even more preferred between 45 and 70 vol %.

The polyamides are noted as described in Nylon Plastics Handbook, Melvin I. Kohan, Hanser Publishers, 1995, page 5. PA-66 refers to poly(hexamethylene adipamide) in which the monomeric units are derived from hexamethylene diamine and adipic acid. PA-410 is a semi-crystalline polyamide in which the monomeric units are derived from 1,4-diaminobutane and sebacic acid.

Polyamide may refer to homopolyamide and copolyamide, as well as blends.

With “homopolyamide” is herein understood to be a polyamide which consists of monomeric units derived from
Aminoacid A, or
Diamine B and diacid C.

A homopolyamide may contain minor amounts of other units, not belonging to the class of aminoacids, diamines or diacids, such as mono-acids or mono-amines. A homopolyamide may also be referred to as PA-A, or PA-BC.

A copolyamide may be referred to as for example PA-NMN, or PA-BC/MN, or PA-NQ, or PA-BC/Q, in which the various letters denote monomeric units derived from different types of aminoacids (A and Q), diamines (B or M) or diacids (C or N). If more than two different types of monomeric units are present, the nomenclature for a copolyamide may be for example PA-NMN/XY.

Blends of polyamides are denoted as PA-A/PA-BC, in which a “/” is placed between the two types of polyamides which are blended.

With the term “copolyamides thereof” is understood that the majority component of the copolyamide is composed of a polyamide listed in the list and a minority component of the copolyamide is composed of monomeric units, being different from that polyamide.

Preferably, PA-66, PA-410 and copolyamides thereof are employed as these exhibit a combination of thermal and environmental resistance, such as resistance against road salts. More preferably, PA-410 is employed as PA-410 surprisingly shows to be resistant against road salts, as well as residues coming from rubber tires, such as sulfuric acid. As the composite is located at the inside of the wheel, it may be subjected to residues migrating out of a rubber tire.

Most preferred, the continuous fiber reinforced composite part comprises a semi-crystalline polyamide in an amount of between 40 and 80 vol % with respect to the total volume of the continuous fiber reinforced composite, wherein the semi-crystalline polyamide is chosen from PA-66 and PA-410 and copolyamides thereof, and the continuous fiber is chosen from glass fiber and carbon fiber and wherein the continuous fiber is present in a vol % of between 20 and 55 vol %, with respect to the total volume of the continuous fiber reinforced composite.

### Continuous Fiber

The continuous fiber reinforced composite part comprises continuous fiber. Continuous fiber as such is known in the art and also referred to as endless fiber and is herein understood to have an aspect ratio of at least 500 before processing. The term “continuous fiber” is herein defined as one or more individual continuous fibers, and thus explicitly includes more than one continuous fiber. For example, the continuous fiber in a tape may have a length of several hundreds of metres and may subsequently be processed into a composite.

The continuous fiber present in the composite in the wheel according to the invention may be chosen from the group consisting of glass fiber, carbon fiber, aramid fiber, basalt fiber and combinations thereof. Preferably, the continuous fiber is glass fiber, as this is generally available. Preferably, the continuous fiber has a sizing in order to improve adhesion between the fiber and the semi-crystalline polyamide.

The volume % of the continuous fiber in the composite usually lies between 10 and 65 volume % as compared to the total volume of the composite, preferably the volume percentage is between 20 and 55 vol %, more preferably the volume percentage is between 30 and 55 vol %. It is usually desirable to have a volume percentage of continuous fiber as high as possible, as this contributes to the strength of the composite.

The continuous fiber reinforced fiber composite part has continuous fiber in a radial direction, also referred to as unidirectional (UD) or 0-90 degrees per layer with respect to the composite, also referred to as cross-ply, or any orientation in between UD and cross-ply. Any orientation between UD and cross-ply is referred to as bi-axial, and may for example plus minus 30, or plus minus 45, with respect to the layers in the composite direction. Preferably, the continuous fiber is in a radial direction in the composite.

### Other Ingredients

The continuous fiber reinforced composite optionally comprises any of the following ingredients such as heat stabilizer, flame retardant, colorant, lubricant, UV stabilizer, impact modifier, nucleating agent, laser absorbing additives and combinations thereof. These ingredients are known to a person skilled in the art and are usually present in minor amounts such as for example between 0.001 wt % and 10 wt % with respect to the total weight of the continuous fiber reinforced composite excluding the weight continuous fiber.

Preferably, the continuous fiber reinforced composite comprises heat stabilizers, chosen from the group of inorganic stabilizers, organic stabilizers comprising a primary antioxidant group, organic stabilizers comprising a hindered amine group and combinations thereof. Preferably, the heat stabilizers are present in an amount of between 0.01 wt % and 8 wt % with respect to the total weight of the continuous fiber reinforced composite excluding the weight of the continuous fiber. Inorganic stabilizers are known and are for example a copper compound and a salt containing a halogenide acid group, for example an iodide or a bromide salt. Good examples of suitable copper compounds include copper (I) halogenides, preferably copper iodide (Cul) and further copper salts like for instance copper acetate, copper sulfate and cupper stearate. As the salt containing an halogenide acid group preferably potassium bromide (KBr) of potassium iodide (KI) are used. Most preferred a combination of copper iodide and potassium bromide (Cul/KBr) is used. Organic stabilizers comprising a primary antioxidant group are radical scavengers such as for example phenolic antioxidants as well as aromatic amines, and are known as such. Suitable organic stabilisers comprising a hindered amine (also known as Hindered Amine Stabilizer; HAS) in the tape according to the invention are for example HAS compounds derived from a substituted piperidine compound, in particular any compound which is derived from an alkyl-substituted piperidinyl or piperazinone compound, and substituted alkoxy peridinyl compounds. More preferably, the continuous fiber reinforced composite comprises a combination of heat stabilizer in which an inorganic stabilizer is employed in combination with an organic stabilizer comprising both a hindered amine group and an organic stabilizer comprising a primary antioxidant. The combination of these 3 stabilizers provides an improved UV stability.

### Process for Preparing a Wheel

The invention also relates to a process for preparing a wheel comprising the following steps:
a. Providing a wheel comprising a metal disk and a rim which rim comprises a metal part;
b. Providing tape comprising continuous fiber present in at least a semi-crystalline polyamide with a melting temperature of at least 180° C.;
c. Treating a surface of the metal part of the rim where a composite is to be placed and/or treating the tape in order to increase adhesion;
d. Applying the tape on at least part of the outer surface of the metal part of the rim;
e. Consolidating the tape and applying pressure, by at least one cycle, thereby forming the composite part of the rim.

Preferably in step a) a wheel is provided in which the metal rim is pre-treated in order to reduce metal thickness at the places in which the tape will be wound.

The treatment in step c) is a process step known per se and includes for example applying glue, plasma treatment, flame treatment or mechanical texturing on the metal rim and/or applying glue, plasma treatment or flame treatment of the tape. Step d) can be performed by for example winding the tape around the outer surface of the metal rim by at least one cycle. Preferably, winding is performed by more than one cycle, thereby forming at least two layers of tape around the outer surface of the metal rim. This has the advantage that rotational weight balance of the wheel may be obtained as well as match durability and functional requirements and enable further consolidation.

Consolidation in step e) can be performed by heat, such as applying a hot gas, a laser or in an oven or a combination thereof.

In step d) and or e) the rim or the tape or both can be rotated around the wheel axis in order to secure careful placement of the tape on the surfaces.

### Tape

The tape as employed in the process for preparing a wheel comprises continuous fiber in a semi-crystalline polyamide with a melting temperature of at least 180° C.

Preferably, the tape comprises at least one layer comprising:
a. continuous fiber in a total amount of at least 40 volume % as compared to the total volume of the layer embedded in a matrix comprising comprising a semi-crystalline polyamide with a melting temperature of at least 180° C.,
b. and optionally heat stabilizer, flame retardant, colorant, lubricant, UV stabilizer, impact modifier, laser absorbing additive as well as combinations thereof.

Suitable continuous fiber present in the tape is described above. Suitable semi-crystalline polyamides with a melting temperature of at least 180° C. are described above.

With tape herein is understood an elongated body having a longitudinal direction, a width, a thickness and a cross-sectional aspect ratio, i.e. the ratio of thickness to width. Said cross-section is defined as substantially perpendicular to the longitudinal direction of the tape.

The longitudinal direction or machine direction of each layer of the tape may correspond to any orientation of the continuous fiber. Each layer of the tape may comprise a multiple stacking of continuous fiber oriented in any direction.

When all continuous fiber is in the longitudinal direction the tape is, the tape is referred to as uni-directional continuous fiber reinforced tape—also known as UD-tape.

If the orientation is 0-90 degrees per layer with respect to the tape direction, it is also referred to as cross-ply. Any orientation between UD and cross-ply is referred to as bi-axial tape, and may for example plus minus 30, or plus minus 45, with respect to the tape direction.

The length dimension of a tape is not particularly limited. The length may exceed 10 km and mainly depends on the continuous fibres and the process used to produce the tape. Nevertheless said tape can for convenience reasons be manufactured to smaller sizes, according to the requirements of the envisioned applications.

The tape may have a thickness of between 100 micrometer and may be as thick as 1000 micrometer. The thickness of the tape is preferably between 100 micrometer and 500 micrometer as thicker tapes are more difficult when winding is used to apply the tape on at least part of the surface of the metal rim.

By width of the tape is herein understood the largest dimension between two points on the perimeter of a cross-section of the tape, said cross-section being orthogonal to the length of the tape. By thickness is herein understood a distance between two points on the perimeter of said cross-section, said distance being perpendicular on the width of the tape. The width and the thickness of a tape can be measured according to known methods in the art, e.g. with the help of a ruler and a microscope or a micrometer, respectively.

The tape comprises at least one layer and may thus be a single layer or two layers or even more layers. If a tape has more than one layer it is also referred to as multi-layer. If the tape is a multi-layer it may comprise several layers of the same material, stacked onto each other. Stacking may be performed by lamination, which is a known process as such. Preferably, the tape consists of one layer as this facilitates production of the tape.

A tape may be produced by processes known in the art and which generally include the steps of providing continuous fiber, also known as rovings, and providing a polyamide as described above, applying heat to above the melting temperature of the polyamide, thereby embedding the fiber with the polyamide and subsequent cooling to obtain the tape.

The volume % of the continuous fiber in the tape usually lies between 10 and 65 volume % as compared to the total volume of the tape, preferably the volume percentage is between 20 and 55 vol %, more preferably the volume percentage is between 30 and 55 vol %. It is usually desirable to have a volume percentage of continuous fiber as high as possible, as this contributes to the strength of the composite to be formed.

The tape usually comprises the semi-crystalline polyamide in an amount of between 25 and 90 vol % with respect to the total volume of the tape, preferably the volume percentage is between 35 and 90 vol %, more preferably between 45 and 80 vol %, even more preferred between 45 and 70 vol %.

The invention also relates to a tape comprising continuous fiber present in at least a semi-crystalline polyamide with a melting temperature of at least 180° C., wherein the semi-crystalline polyamide is PA-410 and the continuous fiber is chosen from the group consisting of glass fiber and carbon fiber and the amount of continuous fiber is between 20 and 55 vol % with respect to the total volume of the tape. Preferably, the orientation of the continuous fiber is in a longitudinal direction. Preferably, the amount of PA-410 in the tape is between 45 and 80 vol % with respect to the total volume of the tape.

### EXAMPLES

The performed test was a rim rolling or radial fatigue test, and represents a qualifier in the industry. The radial fatigue test was used for fatigue and endurance testing of wheels by rolling the wheel on a drum under specific radial load conditions. This radial fatigue test is one of the required legal tests for wheels in most countries worldwide as for example specified in standard SAE J328.

Tapes were made with continuous glass fiber 40 vol % in PA-410. The fibers were arranged in a longitudinal direction. 16 inch wheels were used. The tape had a thickness of 0.25 millimeter and a width 12 millimeter.

Wheel weight is defined here as the weight of the rim and disk.

Tests performed with composite on the wheel in dry state and in ambient environment.

The comparative All-metal wheel was 11.00 kg, which performed with at least 1.000.000 life time at 13.02 kN in the radial fatigue test.

Wheels were made with composite at the drop well with a width of 24 millimeter, by applying 8 layers of tape as prepared above. Results are shown in Table 1.

Wheels were also made with composite present at both bead seats, each having a width of 12 millimeter, by applying 8 layers of tape as prepared above. Results are shown in Table 2.

Table 1 with text results incl. comparative data.

| | | Mass | Load | Number of Cycles |
|---|---|---|---|---|
| | Wheel | Kg | kN | till failure |
| Comparative A | All metal wheel | 11.00 | 13.02 | >1.000.000 |
| Comparative B | Thickness | 9.98 | 13.02 | 578.200 |
| | reduced in drop | | | |
| | well from 2.3 to | | | |
| | 1 mm, no | | | |
| | composite | | | |
| | present | | | |
| Example 1 | Thickness | 10.28 | 13.02 | 1.172.200 |
| | reduced in drop | | | |
| | well from 2.3 to | | | |
| | 1 mm. Composite | | | |
| | present at drop | | | |
| | well. | | | |

Table 2 with test results incl. comparative data

| | | Mass | Load | Number of Cycles |
|---|---|---|---|---|
| | Wheel | Kg | kN | till failure |
| Comparative A | All-metal wheel | 11.00 | 13.02 | >1.000.000 |
| Comparative C | Thickness | 10.08 | 13.02 | 756.000 |
| | reduced in bead | | | |
| | seats from 2.3 to | | | |
| | 1 mm, no | | | |
| | composite | | | |
| | present | | | |
| Example 2 | Thickness | 10.18 | 13.02 | 1.455.800 |
| | reduced in bead | | | |
| | seats from 2.3 to | | | |
| | 1 mm, composite | | | |
| | present at bead | | | |
| | seats. | | | |

From table 1 and 2 it is clear that a wheel according to the invention exhibits a higher cycle number as compared to a wheel which does not comprise the composite (see Example 1 as compared to Comparative B, and Example 2 as compared to Comparative C). The wheels according to the invention exhibit a cycle number which is comparable to an all-metal wheel, which has a weight that is considerably higher than the wheels according to the invention (see Examples 1 and 2, as compared to Comparative A). The wheels according to the invention showed a weight reduction of 7%, which is an important weight reduction for automotive industry.

1. Wheel, comprising a metal disk and a rim which rim comprises a metal part and a continuous fiber reinforced composite part present on an outer surface of the metal part of the rim, wherein the continuous fiber reinforced composite part comprises a semi-crystalline polyamide with a melting temperature of at least 180° C.

2. Wheel according to claim 1, in which the wheel load capacity is at least 200 kg.

3. Wheel according to claim 1, wherein the continuous fiber reinforced composite part has continuous fiber in a radial direction.

4. Wheel according to claim 1, wherein the continuous fiber reinforced composite part is located at at least one of either a bead seat, a drop well or a drop center, or a combination thereof.

5. Wheel according to claim 1, wherein the semi-crystalline polyamide is chosen from the group consisting of PA-6, PA-66, PA-66/6, PA-6/66, PA-6/6T, PA-66/6T, PA-610, PA-410, PA-12, PA-46, PA-510, PA-612 as well as blends and copolyamides thereof.

6. Wheel according to claim 1, wherein the continuous fiber is chosen from the group consisting of glass fiber, carbon fiber, aramid fiber, basalt fiber and combinations thereof.

7. Wheel according to claim 1, wherein the continuous fiber is chosen from the group consisting of glass fiber and carbon fiber and the semi-crystalline polyamide is chosen from the group consisting of PA-66 and PA-410.

8. Process for preparing a wheel according to claim 1, comprising the following steps:
a. Providing a wheel comprising a metal disk and a rim which rim comprises a metal part;
b. Providing tape comprising continuous fiber present in at least a semi-crystalline polyamide with a melting temperature of at least 180° C.;
c. Treating a surface of the metal part of the rim where a composite is to be placed and/or treating the tape in order to increase adhesion;
d. Applying the tape on at least part of the outer surface of the metal part of the rim;
e. Consolidating the tape and applying pressure, by at least one cycle, thereby forming the composite part of the rim.

9. Process according to claim 8, wherein the tape is applied by winding around the outer surface of the metal part of the rim.

10. Process according to claim 9, wherein the tape is applied by more than one winding around the outer surface of the metal part of the rim.

11. Process according to claim 8, wherein the tape is applied at at least one of either a bead seat, a drop well or a drop center, or a combination thereof.
